(19) United States
(12) Patent Application Publication
(10) Pub. No.: US 2007/0127263 A1
(43) Pub. Date: Jun. 7, 2007

(54) Backlight module with light guide plate having flared end portion and liquid crystal display with same

(75) Inventor: Cheng-Fan Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/633,286

(22) Filed: Dec. 4, 2006

(30) Foreign Application Priority Data
Dec. 2, 2005 (TW) 94142478

(51) Int. Cl. F21V 7/04

(52) U.S. Cl. 362/610; 362/615; 362/561

(57) ABSTRACT

An exemplary backlight module (10) includes a light guide plate (12) and an illuminator (14). The light guide plate includes a main body (120), and an end portion (121) outwardly flaring from the main body. The end portion includes a light incident surface (126). The illuminator is located adjacent to the light incident surface, and a horizontal central planar axis (142) of the illuminator and a horizontal central planar axis (127) of the light guide plate being in a same plane.

### FIELD OF THE INVENTION

The present invention relates to backlight modules such as those used in liquid crystal displays (LCDs); and more particularly to a backlight module with a light guide plate (LGP) having a flared end portion, and a liquid crystal display including the backlight module.

### GENERAL BACKGROUND

Liquid crystal displays are commonly used as displays for compact electronic apparatuses, because they not only provide good quality images with little power but are also very thin. The liquid crystal in a liquid crystal display does not emit any light itself. The liquid crystal has to be lit by a light source so as to clearly and sharply display text and images. Thus, a backlight module is generally needed for a liquid crystal display.

Light guide plates are generally used in backlight modules for converting point light sources or linear light sources into surface light sources. These days, light guide plates are commonly manufactured to be very thin, in order to meet the requirements of modem compact liquid crystal display devices.

Referring to FIG. 7, a typical backlight module 70 includes a light guide plate 72, and a light emitting diode (LED) 74. The light guide plate 72 includes a light incident surface 722, and a top surface 724 perpendicularly connected with the light incident surface 722. The light emitting diode 74 is located adjacent to the light incident surface 722 of the light guide plate 72. A height of the light emitting diode 74 is greater than a height of the light incident surface 722, and a horizontal central planar axis 742 of the light emitting diode 74 is higher than a horizontal central planar axis 726 of the light guide plate 72.

The light emitting diode 74 has a limited range of angles of divergence of light beams emitted therefrom. That is, light beams emit from the light emitting diode 74 over a certain spread angle, due to limitations inherent in the structure of the light emitting diode 74 itself. In general, most of the light beams are concentrated around the horizontal central planar axis 742 of the light emitting diode 74, while relatively few light beams project at angles greatly divergent from the horizontal central planar axis 742. Experiments have demonstrated that the greater the vertical distance between the horizontal central planar axis 742 of the light emitting diode 74 and the horizontal central planar axis 726 of the light guide plate 72, the lower the relative emitting luminance of the backlight module 70. The brightness in the light guide plate 72 above the horizontal central planar axis 726 is greater than the brightness in the light guide plate 72 below the horizontal central planar axis 726. This results in non-uniform emission of light from the top surface 724 of the backlight module 70. Further, because the height of the light emitting diode 74 is greater than the height of the light guide plate 72, some light beams emitted from the light emitting diode 74 are liable to bypass the light guide plate 72 altogether and be wasted. This results in a reduced ratio of light utilization of the backlight module 70.

What is needed, therefore, is a backlight module that can overcome the above-described deficiencies. What is also needed is a liquid crystal display employing such a backlight module.

### SUMMARY

In one preferred embodiment, a backlight module includes a light guide plate, and an illuminator. The light guide plate includes a main body, and an end portion outwardly extending from the main body. The end portion includes a light incident surface. The illuminator is located adjacent to the light incident surface. A horizontal central planar axis of the illuminator and a horizontal central planar axis of the light guide plate are coplanar.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is a side view of a backlight module according to a first embodiment of the present invention.

FIG. 2 is a side view of a backlight module according to a second embodiment of the present invention.

FIG. 3 is a side view of a backlight module according to a third embodiment of the present invention.

FIG. 4 is a side view of a backlight module according to a fourth embodiment of the present invention.

FIG. 5 is a top plan view of a backlight module according to a fifth embodiment of the present invention.

FIG. 6 is an exploded, side view of a liquid crystal display including the backlight module of FIG. 1.

FIG. 7 is a side view of a conventional backlight module.

### DETAILED DESCRIPTION OF PREFERRED EMBODIMENTS

Reference will now be made to the drawings to describe the preferred embodiments in detail.

Referring to FIG. 1, a backlight module 10 according to a first embodiment of the present invention is shown. The backlight module 10 includes a light guide plate 12 and an illuminator 14.

The light guide plate 12 includes a main body 120 and an end portion 121. The main body 120 includes a top surface 122, and a bottom surface 123 opposite to the top surface 122. The end portion 121 is integrally formed with the main body 120, and outwardly flares from one end (not labeled) of the main body 120. In the illustrated embodiment, the end portion 121 has an isosceles trapezoidal cross-section, and includes an upper surface 124, a lower surface 125, and a light incident surface 126. The upper surface 124 extends from the top surface 122 of the main body 120. The lower surface 125 extends from the bottom surface 123 of the main body 120. The upper surface 124 and the lower surface 125 are planar, and are symmetrical relative to a horizontal central planar axis 127 of the light guide plate 12. The light incident surface 126 extends between the upper surface 124 and the lower surface 125. The light incident surface 126 is planar, and perpendicular to the horizontal central planar axis 127 of the light guide plate 12. The light guide plate 12 can for example be made from polycarbonate (PC) or polymethyl methacrylate (PMMA), and can be manufactured by an injection molding method.

The illuminator 14 is disposed adjacent to the light incident surface 126. In the illustrated embodiment, the illuminator 14 is a light emitting diode (LED). A height of the illuminator 14 is substantially equal to that of the light incident surface 126. Light beams emit from the illuminator 14 over a certain range of angles of divergence, which is hereinafter referred to as a spread angle. When the illuminator 14 is viewed from above, the spread angle is generally in the range from 30 to 130 degrees, as measured from a front face of the illuminator 14. When the illuminator 14 is viewed from a side thereof, a horizontal central planar axis 142 of the illuminator 14 divides the spread angle into two equal sub-angles. The horizontal central planar axis 142 of the illuminator 14 is perpendicular to the light incident surface 126. The horizontal central planar axis 127 of the light guide plate 12 and the horizontal central planar axis 142 of the illuminator 14 are coplanar.

In operation, light beams emitted from the illuminator 14 transmit into the light guide plate 12 through the light incident surface 126. Because the horizontal central planar axis 127 of the light guide plate 12 and the horizontal central planar axis 142 of the illuminator 14 are coplanar, a brightness below the horizontal central planar axis 127 of the light guide plate 12 is substantially equal to a brightness above the horizontal central planar axis 127. This enables the light guide plate 12 to provide uniform emission of light from the top surface 122, the bottom surface 123, or both the top and bottom surfaces 122, 123 (depending on the actual configuration and application of the backlight module 10). Further, the horizontal central planar axis 142 of the illuminator 14 is perpendicular to the light incident surface 126, and the height of the illuminator 14 is substantially equal to that of the light incident surface 126. Therefore when the illuminator 14 is positioned a proper distance from the light incident surface 126 of the light guide plate 12, substantially all the light beams emitted from the illuminator 14 can transmit into the light guide plate 12 through the light incident surface 126. Thus, a ratio of light utilization of the backlight module 10 can be improved.

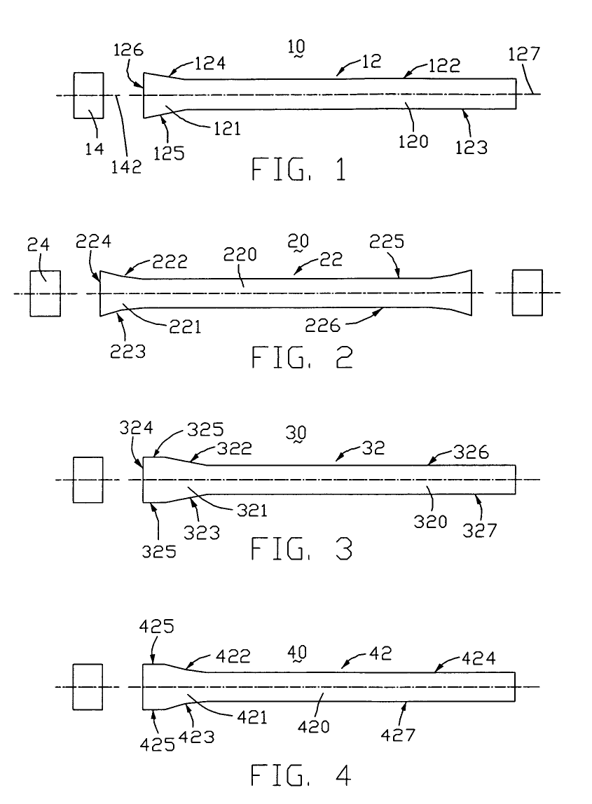

Referring to FIG. 2, a backlight module 20 according to a second embodiment of the present invention is similar to the backlight module 10. However, a light guide plate 22 of the backlight module 20 includes a main body 220, and two end portions 221 outwardly flaring from two opposite ends (not labeled) of the main body 220, respectively. Each end portion 221 includes an upper surface 222, a lower surface 223, and a light incident surface 224. The upper surfaces 222 respectively extend from a top surface 225 of the main body 220. The lower surfaces 223 respectively extend from a bottom surface 226 of the main body 220. Each light incident surface 224 extends between the corresponding upper surface 222 and the corresponding lower surface 223. The upper surfaces 222 and the lower surfaces 223 are curved inwardly. In the illustrated embodiment, the upper surfaces 222 and the lower surfaces 223 are generally arc-shaped. The backlight module 20 further includes two illuminators 24 located adjacent to the light incident surfaces 224 of the end portions 221, respectively. The backlight module 20 can achieve advantages similar to those of the backlight module 10.

Referring to FIG. 3, a backlight module 30 according to a third embodiment of the present invention is similar to the backlight module 10. However, a light guide plate 32 of the backlight module 30 includes a main body 320 and an end portion 321. The end portion 321 outwardly flares from one end of the main body 320. The end portion 321 includes an upper surface 322, a lower surface 323, a light incident surface 324, and two opposite connection surfaces 325. The upper surface 322, lower surface 323, light incident surface 324, and connection surfaces 325 are all planar. The upper surface 322 extends from a top surface 326 of the main body 320. The lower surface 323 extends from a bottom surface 327 of the main body 320. One of the connection surfaces 325 extends between the upper surface 322 and the light incident surface 324. The other connection surface 325 extends between the lower surface 323 and the light incident surface 324. The connection surfaces 325 each perpendicularly extend from the light incident surface 324. The backlight module 30 can achieve advantages similar to those of the backlight module 10.

Referring to FIG. 4, a backlight module 40 according to a fourth embodiment of the present invention is similar to the backlight module 30. However, a light guide plate 42 of the backlight module 40 includes a main body 420, and an end portion 421 outwardly flaring from one end of the main body 420. The end portion 421 includes an upper surface 422, a lower surface 423, and two opposite connection surfaces 425. The upper surface 422 extends between a top surface 424 of the main body 420 and one of the connection surfaces 425. The lower surface 423 extends between a bottom surface 427 of the main body 420 and the other connection surface 425. The upper surface 422 and the lower surface 423 are curved inwardly. In the illustrated embodiment, the upper surface 422 and the lower surface 423 are generally arc-shaped. The backlight module 40 can achieve advantages similar to those of the backlight module 30.

Referring to FIG. 5, a backlight module 50 according to a fifth embodiment of the present invention is similar to the backlight module 10. However, the backlight module 50 includes a light guide plate 52 and a plurality of illuminators 54. In the illustrated embodiment, the plurality of illuminators 54 are three light emitting diodes 54. A vertical central planar axis 542 of a central one of the illuminators 54 and a vertical central planar axis 524 of the light guide plate 52 are coplanar. The other two illuminators 54 are symmetrically located relative to the vertical central planar axis 542 of the central illuminator 54. The backlight module 50 can achieve advantages similar to those of the backlight module 10.

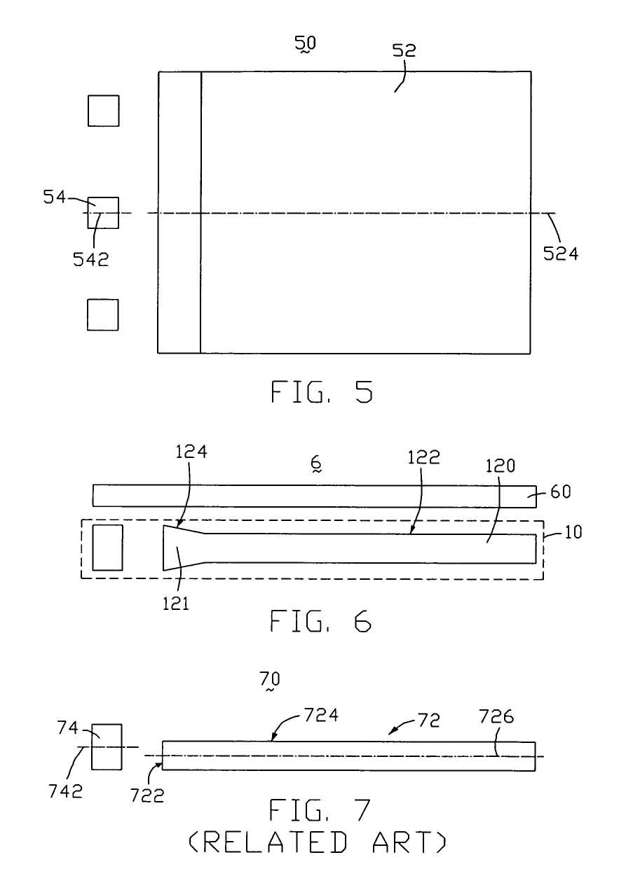

Referring to FIG. 6, a liquid crystal display 6 having the backlight module 10 is shown. The liquid crystal display 6 includes a liquid crystal panel 60 and the backlight module 10. The top surface 122 of the main body 120 and the upper surface 124 of the end portion 121 are adjacent to the liquid crystal panel 60. The top and upper surfaces 122, 124 cooperatively function as a light emitting surface of the backlight module 10. In alternative embodiments, the backlight module 10 can be replaced with any one of the above-described backlight modules 20, 30, 40, 50.

Further or alternative embodiments may include the following. In one example, the light emitting diodes 24, 54 can each instead be another kind of illuminator that has a certain spread angle. In another example, the end portion 121, 221, 321, 421 can have other suitable symmetrical shapes or asymmetrical shapes.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate comprising:
a main body; and
an end portion outwardly flaring from the main body, the end portion comprising a light incident surface; and
an illuminator located adjacent to the light incident surface, wherein a horizontal central planar axis of the illuminator and a horizontal central planar axis of the light guide plate are coplanar.

2. The backlight module in claim 1, wherein light beams emit from the illuminator over a certain range of angles of divergence.

3. The backlight module in claim 2, wherein the range of angles of divergence defines a spread angle, and when the illuminator is viewed from above, the spread angle is in the range from 30 to 130 degrees as measured from a front face of the illuminator.

4. The backlight module in claim 3, wherein the horizontal central planar axis of the illuminator is perpendicular to the light incident surface of the light guide plate, and when the illuminator is viewed from a side thereof, the horizontal central planar axis of the illuminator divides the spread angle into two equal sub-angles.

5. The backlight module in claim 1, wherein the main body comprises a top surface and a bottom surface, the end portion further comprises an upper surface and a lower surface, the upper surface is adjacent to the top surface, and the lower surface is adjacent to the bottom surface.

6. The backlight module in claim 5, wherein the upper surface and the lower surface are each adjacent to the light incident surface.

7. The backlight module in claim 5, wherein the upper surface and the lower surface are symmetrical relative to the horizontal central planar axis of the light guide plate.

8. The backlight module in claim 5, wherein the upper surface and the lower surface are planar.

9. The backlight module in claim 5, wherein the upper surface and the lower surface are curved inwardly.

10. The backlight module in claim 5, wherein the end portion further comprises a first connection surface between the upper surface and the light incident surface, and a second connection surface between the lower surface and the light incident surface.

11. The backlight module in claim 1, further comprising at least another illuminator located adjacent to the light incident surface, wherein said illuminator and said at least another illuminator are aligned parallel to the light incident surface and arranged to be symmetrical relative to a vertical central planar axis of the light guide plate.

12. The backlight module in claim 11, wherein said at least another illuminator is two other illuminators, and a vertical central planar axis of a central one of the three illuminators and the vertical central planar axis of the light guide plate are coplanar.

13. The backlight module in claim 1, wherein a height of the illuminator is substantially equal to that of the light incident surface.

14. The backlight module in claim 1, wherein the illuminator is a light emitting diode.

15. A liquid crystal display comprising:
a liquid crystal panel; and
a backlight module adjacent to the liquid crystal panel, the backlight module comprising:
a light guide plate comprising:
a main body; and
an end portion outwardly flaring from the main body, the end portion comprising a light incident surface; and
an illuminator located adjacent to the light incident surface, wherein a horizontal central planar axis of the illuminator and a horizontal central planar axis of the light guide plate are coplanar.

16. The liquid crystal display in claim 15, wherein a height of the illuminator is substantially equal to a height of the light incident surface of the light guide plate.

17. A backlight module comprising:
a light guide plate comprising:
a main body; and
an end portion outwardly flaring from the main body, the end portion comprising a light incident surface; and
an illuminator located facing to the light incident surface, wherein the illuminator defines a central horizontal plane to which the illuminator is symmetrically arranged, and the light guide plate defines another central horizontal plane to which the light guide plate is symmetrically arranged, said central horizontal plane being coplanar with said another central horizontal plane.
